(19) United States
(12) Patent Application Publication
(10) Pub. No.: US 2007/0013513 A1
(43) Pub. Date: Jan. 18, 2007

(54) Wireless surveillance system

(76) Inventors: Kenneth Y. Tang, Alpine, CA (US); Lance Brees, San Diego, CA (US); Richard Chedester, Whately, MA (US)

Correspondence Address: TREX ENTERPRISES CORP., 10455 PACIFIC COURT, SAN DIEGO, CA, 92121, US

(21) Appl. No.: 11/392,376

(22) Filed: Mar. 28, 2006

Related U.S. Application Data
(63) Continuation-in-part of application No. 10/859,006, filed on Jun. 2, 2004.
(63) Continuation-in-part of application No. 10/799,255, filed on Mar. 12, 2004, now abandoned.
Application No. 10/799,255 is a continuation-in-part of application No. 09/847,629, filed on May 2, 2001, now Pat. No. 6,556,836.
(60) Provisional application No. 60/666,084, filed on Mar. 28, 2005.
(60) Provisional application No. 60/691,270, filed on Jun. 15, 2005.

(51) Int. Cl. G08B 13/00; H04N 7/18

(52) U.S. Cl. 340/541; 348/143

(57) ABSTRACT

A surveillance system utilizing existing street lighting equipment. In a preferred embodiment, surveillance units include a small camera and a wireless transceiver and a connector that allows the surveillance units to plug into an existing outdoor light in the place of the outdoor lights' photo cells. In this preferred embodiment communication between the lights and the cellular station is at frequencies of about 2.4 GHz and uses the 802.11b protocol that permits transmission of data at up to 11 million bits per second or the 802.11g protocol that permits transmission of data at up to 54 million bits per second. The cellular stations then communicates with the central monitoring station at a frequency range of 71-76 GHz and 81 to 86 GHz that permits transmission of data at about 1.0 billion bits per second. In an example system, with 1,000 surveillance cameras (each camera unit plugged into the photocell receptacle of a street light), 100 camera units communicate with each of 10 cellular stations and the 10 cellular stations communicate with a single central monitoring station.

The present invention is a continuation in part of Ser. No. 10/859,006 filed Jun. 2, 2004 and a continuation in part application of Ser. No. 10/799,255 filed Mar. 30, 2004 which is a continuation in part of Ser. No. 09/847,629 filed Sep. 14, 2001, now U.S. Pat. No. 6,714,800 issued Mar. 30, 2004. This application also claims the benefit of Ser. No. 60/666,084, filed Mar. 28, 2005 and Ser. No. 60/691,270 filed Jun. 15, 2008. The present invention relates to outdoor lighting and surveillance and security systems and in particular to the combination of outdoor lighting with wireless surveillance security systems.

### BACKGROUND OF THE INVENTION

### Need for Security

Especially since Sep. 11, 2001 security has become big business in the United States and in most countries of the world. People and governments are concerned with the protection of locations that are terrorist targets. These include stadiums, government installations and military installations. Most terrorist targets are equipped with perimeter outdoor lighting.

### Local Wireless Radio Communication

Local wireless communication services represent a very rapidly growing industry. Wireless communication equipment in the Unites States includes equipment known as “Wireless Fidelity” equipment (also called “WiFi” or “Wireless Networking”). This equipment operates in unlicensed spectral ranges. In order to limit interference among signals, however, transmitted power of WiFi systems is limited. For some services such as cellular telephone services spectral ranges are strictly licensed by region by the federal government.

### Closed Circuit Television

The worldwide CCTV market is growing at a fast pace to a projected $8 billion by 2008. We believe that a video surveillance network with a mesh architecture will address a meaningful niche opportunity for wide- and dense-area surveillance systems. Examples of applications include urban video monitoring systems for law enforcement, wide-area perimeter security systems and single-building systems that require protection for multiple sites at the building.

### Wireless Fidelity Equipment

Wireless fidelity equipment is widely available in the Unites States. It is widely used to connect notebook type computers to the Internet. This type of equipment is designed to standard protocols known as the 802.11b and 802.11g protocols so that transmitted signals to and from the equipment is compatible with Ethernet network systems. That is, the wireless link between WiFi equipment replaces cables in a wired Ethernet system. This equipment operates within the spectral range of 2.412 GHz to 2.462 GHz. This equipment is equipped with either an omni-directional antenna that provides communication in all directions but at maximum distances of only a few hundred feet or a directional antenna that can provide communication at distances or up to a mile or more.

### Remote WiFi Camera Systems

Remote wireless cameras with built-in wireless fidelity communication equipment is currently available from many suppliers such as for example the Wireless Observer XT unit available online at the Internet from Veo International. Equipment available from Veo includes a motion detector that will turn on the remote camera when motion is detected in its field of view transmit the camera's signal (including sound) to a personnel computer. Frame rates up to 30 frames per second are provided. The motion detector can initiate an e-mail that transmits a signal to turn off the camera when the motion ceases. WiFi signals from these remote wireless cameras can be transmitted to a personal computer connected to the Internet and the personal computer can be accessed from just about anywhere in the world. So a person in Singapore can see what is happening in his back yard in San Diego, Calif., just by logging on to his computer that is connected to the Internet. The Observer XT camera has a pan and tilt direction control so the person in Singapore can view his entire San Diego back yard.

### Cellular Telephones

The cellular telephone industry currently is in its second generation with several types of cellular telephone systems being promoted. The cellular market in the United States grew from about 2 million subscribers and $2 million in revenue in 1988 to more than 60 million subscribers about $30 billion in revenue in 1998 and the growth is continuing in the United States and also around the world as the services become more available and prices decrease.

FIG. 5 describes a typical cellular telephone system. A cellular service provider divides its territory up into hexagonal cells as shown in FIG. 5. These cells may be about 5 miles across, although in densely populated regions with many users these cells may be broken up into much smaller cells called micro cells. This is done because cellular providers are allocated only a limited portion of the radio spectrum. For example, one spectral range allocated for cellular communication is the spectral range: 824 MHz to 901 MHz. (Another spectral range allocated to cellular service is 1.8 GHz to 1.9 GHz) A provider operating in the 824-901 MHz range may set up its system, for the cellular stations to transmit in the 824 MHz to 851 MHz range and to receive in the 869 MHz to 901 MHz range. The transmitters both at the cellular stations and in devices used by subscribers operate at very low power (just a few Watts) so signals generated in a cell do not provide interference in any other cells beyond immediate adjacent cells. By breaking its allocated transmitting spectrum and receive spectrum in seven parts (A-G) with the hexagonal cell pattern, a service provider can set up its system so that there is a two-cell separation between the same frequencies for transmit or receive, as shown in FIG. 5. A one-cell separation can be provided by breaking the spectrum into three parts. Therefore, these three or seven spectral ranges can be used over and over again throughout the territory of the cellular service provider. In a typical cellular system each cell (with a transmit bandwidth and a receive bandwidth each at about 12 MHz wide) can handle as many as about 1200 two-way telephone communications within the cell simultaneously. With lower quality communication, up to about 9000 calls can be handled in the 12 MHz bandwidth. Several different techniques are widely used in the industry to divide up the spectrum within a given cell. These techniques include analog and digital transmission and several techniques for multiplexing the digital signals. These techniques are discussed at pages 313 to 316 in The Essential Guide to Telecommunications, Second Edition, published by Prentice Hall and many other sources. Third generation cellular communication systems promise substantial improvements with more efficient use of the communication spectra.

### Other Prior Art Wireless Communication Techniques

### Point-to-Point and Point-to-Multi-Point

Most wireless communication, at least in terms of data transmitted is one way, point to multi-point, which includes commercial radio and television. There are many examples of point-to-point wireless communication. Cellular telephone systems, discussed above, are examples of low-data-rate, point-to-point communication. Microwave transmitters on telephone system trunk lines are another example of prior art, point-to-point wireless communication at much higher data rates. The prior art includes a few examples of point-to-point laser communication at infrared and visible wavelengths.

### Information Transmission

Analog techniques for transmission of information are still widely used; however, there has recently been extensive conversion to digital, and in the foreseeable future transmission of information will be mostly digital with volume measured in bits per second. To transmit a typical telephone conversation digitally utilizes about 5,000 bits per second (5 Kbits per second). Typical personal computer modems connected to the Internet operate at, for example, 56 Kbits per second. Music can be transmitted point to point in real time with good quality using MP3 technology at digital data rates of 64 Kbits per second. Video can be transmitted in real time at data rates of about 5 million bits per second (5 Mbits per second). Broadcast quality video is typically at 45 or 90 Mbps. Companies (such as line telephone, cellular telephone and cable companies) providing point-to-point communication services build trunk lines to serve as parts of communication links for their point-to-point customers. These trunk lines typically carry hundreds or thousands of messages simultaneously using multiplexing techniques. Thus, high volume trunk lines must be able to transmit in the gigabit (billion bits, Gbits, per second) range. Most modem trunk lines utilize fiber optic lines. A typical fiber optic line can carry about 2 to 10 Gbits per second and many separate fibers can be included in a trunk line so that fiber optic trunk lines can be designed and constructed to carry any volume of information desired virtually without limit. However, the construction of fiber optic trunk lines is expensive (sometimes very expensive) and the design and the construction of these lines can often take many months especially if the route is over private property or produces environmental controversy. Often the expected revenue from the potential users of a particular trunk line under consideration does not justify the cost of the fiber optic trunk line. Digital microwave communication has been available since the mid-1970's. Service in the 18-23 GHz radio spectrum is called “short-haul microwave” providing point-to-point service operating between 2 and 7 miles and supporting between four to eight Ti links (each at 1.544 Mbps). Recently, microwave systems operating in the 11 to 38 Ghz band have been designed to transmit at rates up to 155 Mbps (which is a standard transmit frequency known as “OC-3 Standard”) using high order modulation schemes.

### Data Rate and Frequency

Bandwidth-efficient modulation schemes allow, as a general rule, transmission of data at rates of about 1 to 8 bits per second per Hz of available bandwidth in spectral ranges including radio wave lengths to microwave wavelengths. Data transmission requirements of 1 to tens of Gbps thus would require hundreds of MHz of available bandwidth for transmission. Equitable sharing of the frequency spectrum between radio, television, telephone, emergency services, military and other services typically limits specific frequency band allocations to about 10% fractional bandwidth (i.e., range of frequencies equal to about 10% of center frequency). AM radio, at almost 100% fractional bandwidth (550 to 1650 GHz) is an anomaly; FM radio, at 20% fractional bandwidth, is also atypical compared to more recent frequency allocations, which rarely exceed 10% fractional bandwidth.

### Reliability Requirements

Reliability typically required for wireless data transmission is very high, consistent with that required for hard-wired links including fiber optics. Typical specifications for error rates are less than one bit in ten billion (10⁻¹⁰ bit-error rates), and link availability of 99.999% (5 minutes of down time per year). This necessitates all-weather link operability, in fog and snow, and at rain rates up to 100 mm/hour in many areas. On the other hand cellular telephone systems do not require such high reliability.

### Weather Conditions

In conjunction with the above availability requirements, weather-related attenuation limits the useful range of wireless data transmission at all wavelengths shorter than the very long radio waves. Typical ranges in a heavy rainstorm for optical links (i.e., laser communication links) are 100 meters, and for microwave links, 10,000 meters. Atmospheric attenuation of electromagnetic radiation increases generally with frequency in the microwave and millimeter-wave bands. However, excitation of rotational modes in oxygen and water vapor molecules absorbs radiation preferentially in bands near 60 and 118 GHz (oxygen) and near 23 and 183 GHz (water vapor). Rain, which attenuates through large-angle scattering, increases monotonically with frequency from 3 to nearly 200 GHz. At the higher, millimeter-wave frequencies, (i.e., 30 GHz to 300 GHz corresponding to wavelengths of 1.0 centimeter to 1.0 millimeter) where available bandwidth is highest, rain attenuation in very bad weather limits reliable wireless link performance to distances of 1 mile or less. At microwave frequencies near and below 10 GHz, link distances to 10 miles can be achieved even in heavy rain with high reliability, but the available bandwidth is much lower.

### Small Cameras

Small digital cameras are available that are capable of operation at video rates or frame by frame. These cameras are equipped with pixel arrays and the pixels are typically charge couple devices (CCD's) or complementary metal oxide semiconductor (CMOS) devices. These cameras are currently being used extensively in cell phone to transmit images still or video via cell phone systems. A 0.3 mega pixel CMOS camera that fits in a one cubic centimeter volume is described in U.S. Pat. No. 6,730,900 (incorporated herein by reference).

### Outdoor Lighting

Outdoor lighting is provided for most city streets throughout the United States. Parking lots at commercial and industrial facilities are also typically equipped with outdoor lights. Outdoor perimeter lights are also typically provided at industrial and commercial facilities. These are just particular examples; outdoor lighting in general is very common wherever there are people. For many years many (if not most) light fixtures for outdoor street lights, parking lot lights and outdoor perimeter lights have included photocells that turn off the lights in the daytime and turn them on when it gets dark. Typically, each fixture has a photo cell unit on top of the fixture that includes a switch within the unit that opens when a photo cell in the unit detects light levels above a predetermined threshold and closes the switch when the light level drops below either the same or a different threshold. A typical outdoor light 2 is shown in FIG. 1A. This is a 175-watt mercury vapor light sold by Designers Edge with offices in Bellevue, Wash. Applicants obtained this one from a Dixie Line store in San Diego for less than $30. The light is powered by standard 120 volt electric power. The light includes a standard 175 Watt mercury vapor lamp (not shown) and a mercury vapor light fixture 4 and acrylic lens 6 shown in FIG. 1B other fixture components shown in FIG. 1C. The mercury lamp however operates at a much higher voltage provided by a step-up transformer in the fixture. The light also includes photocell 12 that operates at 120 volts. The photocell operates in parallel with the mercury vapor lamp as indicated by the simplified circuit shown in FIG. 2. The photocell has a three prong plug and twist male connector that plugs as shown at 8 into a three prong socket on the top of fixture 2. One of the prongs is a neutral connection 12. The other two are hot wire prongs, one hot wire carrying current to the photocell and the other hot wire 16 carrying current to fixture transformer 18.

Street lights are typically powered at standard voltages such as 120, 240 or 277 volts but utilize lamps that (like the above example) operate at much higher voltages. The higher voltages are provided with a step-up transformer in the light fixture. However, as described above, the photocell operates at the standard voltage and plugs into a receptacle at the top of the fixture. It is known in the prior art to tap into these low voltage receptacles for power for equipment other than photocells. For example, it is known to install cell phone repeaters on light poles and to power them by plugging a the repeater power cable into the photocell receptacle.

### Prior Art Security Systems Utilizing Outdoor Lights

The combining of outdoor lighting into a security system is well known. For example, U.S. Pat. No. 6,819,239 describes a lighting security system in which digital cameras and motion sensors are combined with outdoor lights. In that invention when a motion detector sensed motion one of the lights is caused to turn on and the turned on light caused all the other lights in the system to turn on and cameras associated with each light then records a portion of a region being monitored. This patent cites 21 related patents covering various security ideas.

### Wireless Surveillance

There is no viable solution today for large-scale deployment of video surveillance cameras throughout a large campus or metropolitan areas or at a single facility with large numbers of entrances and exits or other areas that require surveillance. There are various proprietary solutions that provide wireless for video surveillance as indicated above, but they use technology that was developed for wireless internet access, not high bandwidth video surveillance over either a wide area or that requires substantial density or cameras on a particular site.

### The Need

Homeland security is a top priority in the United States. Many thousands of facilities are potential targets of people that want to cause us harm. What we need is a surveillance system that covers a wide are is inexpensive and extremely easy to set up.

### SUMMARY OF THE INVENTION

The present invention provides a surveillance system utilizing existing street lighting equipment. In a preferred embodiment, surveillance units include a small camera and a wireless transceiver and a connector that allows the surveillance units to plug into an existing outdoor light in the place of the outdoor lights' photo cells. In this preferred embodiment communication between the lights and the cellular station is at frequencies of about 2.4 GHz and uses the 802.11b protocol that permits transmission of data at up to 11 million bits per second or the 802.11g protocol that permits transmission of data at up to 54 million bits per second. The cellular stations then communicates with the central monitoring station at a frequency range of 71-76 GHz and 81 to 86 GHz that permits transmission of data at about 1.0 billion bits per second. In an example system, with 1,000 surveillance cameras (each camera unit plugged into the photocell receptacle of a street light), 100 camera units communicate with each of 10 cellular stations and the 10 cellular stations communicate with a single central monitoring station.

### BRIEF DESCRIPTION OF THE DRAWINGS

FIGS. 1A, 1B and 1C are drawings of a prior art 175 Watt mercury vapor outdoor light and some of its components including a photocell switch.

FIG. 2 is a simplified electrical drawing explaining the function of the photo cell switch in the prior art outdoor light.

FIG. 3 is a drawing of a surveillance unit plugged into the photocell receptacle of an outdoor light.

FIG. 4 is a drawing of an example of a preferred embodiment of the present invention providing 1,000 locations.

FIG. 5 shows a prior art cellular telephone system.

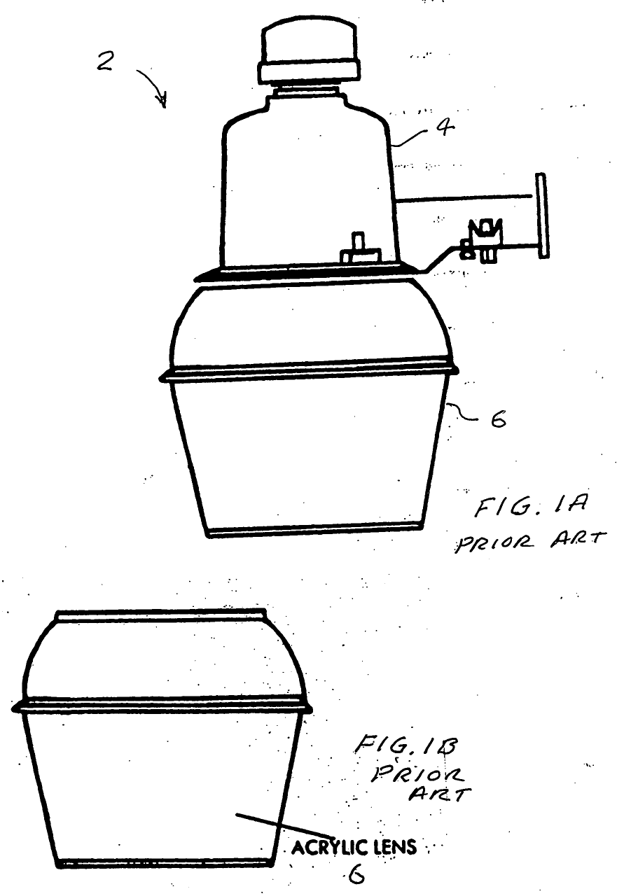

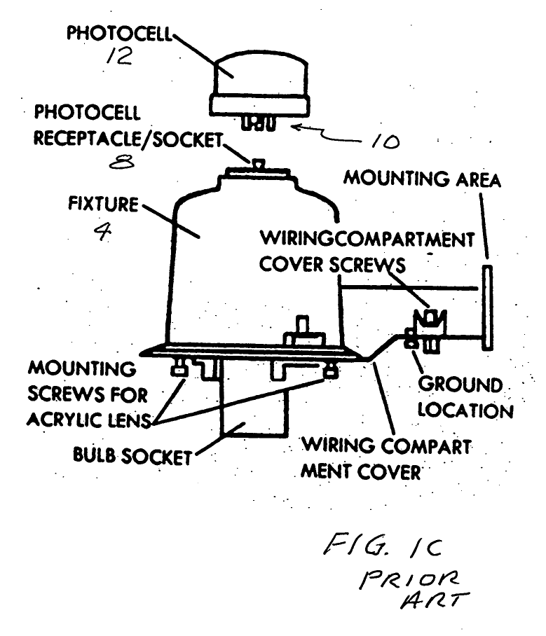

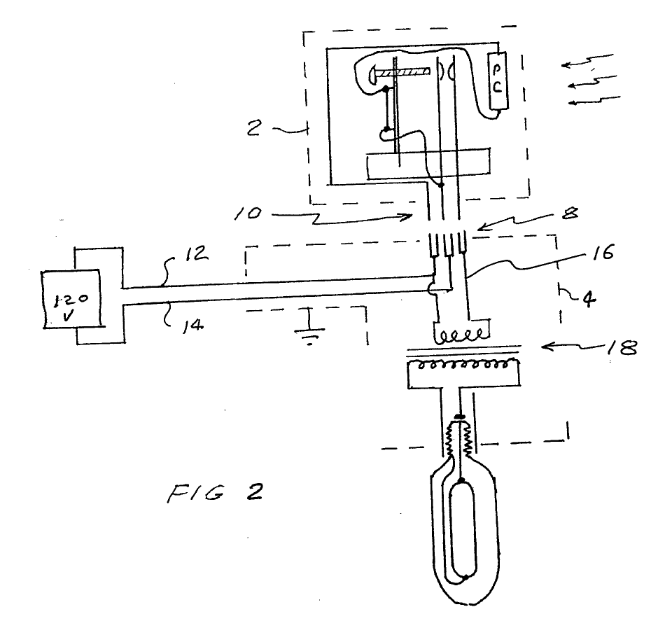

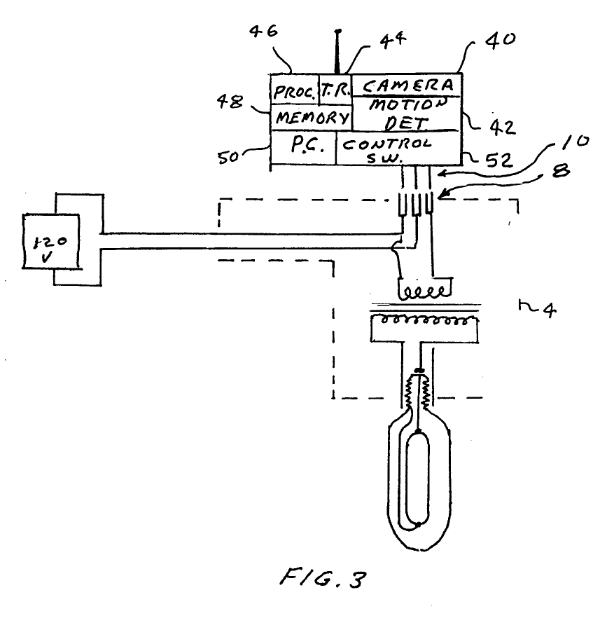

### DETAILED DESCRIPTION OF PREFERRED EMBODIMENTS

### Wireless Outdoor Light Surveillance System

FIG. 3 is a drawing of a surveillance unit plugged into the photocell receptacle of an outdoor light. The surveillance unit includes a small digital CMOS camera 40, a motion detector 42, transceiver 44, a computer processor 46, memory unit 48, photocell 50 and control switch 52. All of these electronic components are available individually off the shelf and all of the components except the photocell and the control switch are currently being utilized in digital surveillance wireless camera units that are also currently available from suppliers such as Veo International. The unique feature of this embodiment is that it plugs into the photocell receptacle 8 of light fixture 4. The very important advantage of this feature is that a surveillance station can be set up in just a very few minutes at negligible installation cost utilizing existing street lighting, parking lot lighting and perimeter lighting. Low cost of the individual units will encourage installation of wide ranging surveillance systems.

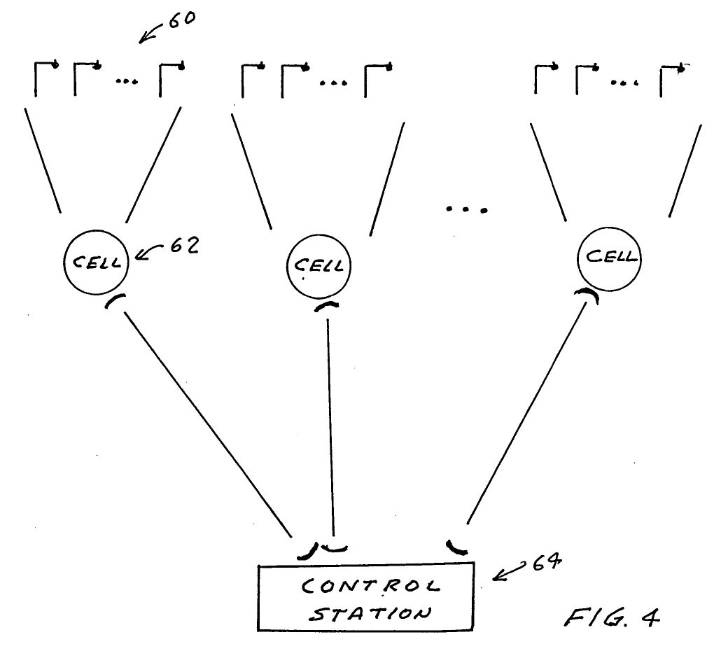

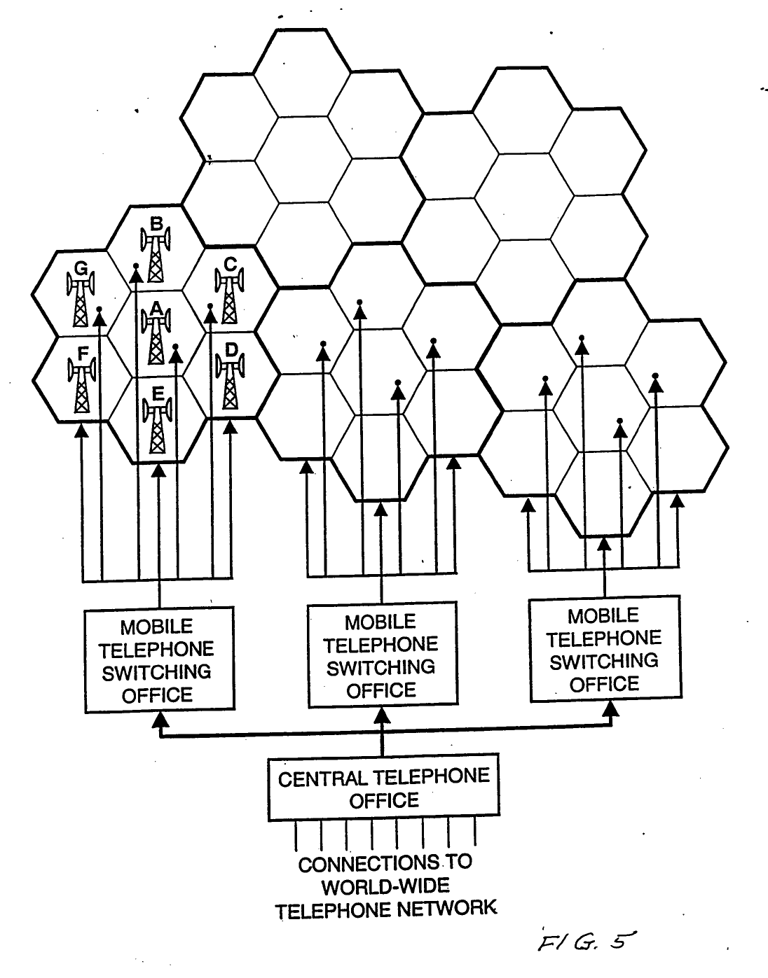

Preferably a number of surveillance units communicate with a single cellular station (referred to as a node above) as shown in FIG. 4. In this preferred embodiment communication between the lights 60 and the cellular stations 62 is at frequencies of about 2.4 GHz and uses the 802.11b protocol that permits transmission of data at up to 11 million bits per second or 802.11g protocol that permits transmission of data at up to 54 million bits per second. For use at a single location such as security for a factory of power plant utilizing less than about 100 surveillance units, monitoring can take place at a single cellular station. However, for larger installation such as for a medium size city, several to many cellular stations communicate with a central monitoring station 64. These links should have data transmission capacity sufficient to carry surveillance data at desired rates. Therefore, the links could be cable or fiber optic links. A preferred alternative, however, is to utilize millimeter wave radio links. Some of the Applicants have invented a millimeter radio link that operates at frequency ranges of 71-76 GHz and 81 to 86 GHz and permits transmission of data at about 1.0 billion bits per second. Such a link is described in parent applications Ser. No. 10/859,006 and Ser. No. 10/799,255, both of which have been incorporated by reference. In an example system, with 1,000 surveillance cameras (each camera unit plugged into the photocell receptacle of a street light), 100 camera units communicate with each of 10 cellular stations and the 10 cellular stations communicate with a single central monitoring station. In a large city cellular stations could be located in or on large buildings to provide unobstructed communications to the surveillance units on the street lights. Free space laser communication could also be used for the links between the cellular stations and the control station. Backup communication links such as microwave links might be provided for the laser links that do not perform very well in rain or snow. Backup links might also be desirable for the millimeter radio links in case of extremely bad weather. The backup links could be links with much reduce data carrying capacities and procedures could be developed to transmit only the most needed information in the case of a switch to the backup links.

### Compact Unit

Use of currently available off-the-shelf components will require that the unit be somewhat larger than the photo-cell switch it replaces. However, the components preferably be minimized using well-known techniques so that the unit is about the same size as the existing photo-cell switch.

### Applications

The present invention can be utilized everywhere outdoor lights exist. Most outdoor lights are at least in part provided for security purposes. The lights allow someone to see what darkness would otherwise obscure. If no one is looking, however, the lights may fail their purpose. The present invention permits monitoring wherever there is an outdoor light by police or security personnel. With the preferred embodiment of FIG. 4, police could monitor an entire city from the central control station or sub stations that can be tied into the central station. It is not practicable for personnel to monitor video from all 1,000 surveillance units; however, each unit can be programmed to store periodic images for later retrieval. Also, in the preferred embodiment the units can be programmed to alert the central office when the motion detector detects motion of a predetermined type. All of the units, or a selected portion of them (such as those in a high crime region), can be programmed to transmit a still frame once each 5 seconds to a small set of monitors that can be monitored by only a few personnel. In case of a report of questionable activity in a particular location, the surveillance units in that location can be quickly programmed to transmit video or still frames of what's going on.

The present invention is useful for providing surveillance at military bases and the system can be rapidly set up in battlefield situations. Advancing enemy positions can be precisely located and destroyed even from the central station using GPS guided weapons.

### Variations

Persons skilled in this art will recognize that many variations to the above embodiments are possible and may be desirable. For example, sound detection equipment can be added to the surveillance units and microphones could also be added so that security personnel could communicate from the central station to people in the location of the surveillance unit. Other sensors that could be added include smoke detectors, radiation detectors, motion detectors, speed (Doppler) detectors. A street light with a Doppler speed detector could be programmed to report speeding vehicles to the central monitoring station or to nearby police and to save images and speed data for trial. Many variations collecting and storing information collected by the surveillance are possible. The information can be stored in the unit itself, at the cellular units or at the central station. Or it could be temporally stored in the units then down loaded periodically to the central station. It will be desirable to provide a variety of surveillance units that can plug into all of the major models of existing light fixtures with plug-in photocells in order to match plug configuration and fixture voltage and frequency. Another alternative is to provide a standard surveillance unit and adapters to connect the standard to the various fixtures design. Communication between the surveillance could utilize cell phone technology, both at the surveillance units and at the cellular stations. It may be desirable even to use some of the cell phone central station technology at the control station. In some cases it may be desirable to install a surveillance unit on a light pole separate from the fixture. In this case electric power to the surveillance unit can be provided through an adapter that is inserted between the fixture and the photocell.

While preferred embodiments of the present invention are described in detail, the reader should understand that the scope of the invention is not limited to those embodiments but should be determined by the claims and their legal equivalents.

We claim:

1. A surveillance system utilizing existing lighting equipment comprising:
A) a plurality of outdoor lighting unit photo-cell replacement units, each photo-cell replacement unit comprising:
1) a small camera,
2) a wireless transceiver,
3) a connector adapted to permit the replacement unit to plug into an existing outdoor light in the place of the outdoor lights' photo cells.
B) At least one cellular station in wireless communication with one or more of said plurality of photo-cell replacement units.

2. The surveillance system as in claim 1 wherein said cellular station is a plurality of cellular stations and also comprising a central monitoring station in communication with said plurality of cellular stations.

3. The surveillance system as in claim 1 wherein communication between the photo-cell replacement units and the cellular station is at frequencies of about 2.4 GHz and uses the 802.11b protocol that permits transmission of data at up to 11 million bits per second or the 802.11g protocol that permits transmission of data at up to 54 million bits per second.

4. The surveillance system as in claim 2, wherein communication between the cellular stations and the central monitoring station is wireless communication.

5. The surveillance system as in claim 4 wherein the wireless communication is at a frequency range of 71-76 GHz and 81 to 86 GHz that permits transmission of data at about 1.0 billion bits per second.

6. The surveillance system as in claim 5 wherein said system includes at least 1,000 surveillance cameras with each camera unit plugged into the photocell receptacle of a street light, at least 100 camera units communicate with at least one of at least 10 cellular stations and the at least 10 cellular stations communicate with a single central monitoring station.
